(19) United States
(12) Patent Application Publication
(10) Pub. No.: US 2014/0215373 A1
(43) Pub. Date: Jul. 31, 2014

(54) COMPUTING SYSTEM WITH CONTENT ACCESS MECHANISM AND METHOD OF OPERATION THEREOF

(71) Applicant: Samsung Electronics Co., Ltd., Suwon-si (KR)

(72) Inventors: Nina F. Shih, Mountain View, CA (US); Yun Z. Wu, San Francisco, CA (US); Guy Bar-Nahum, San Francisco, CA (US); Joshua Adam Bloom, San Francisco, CA (US)

(73) Assignee: Samsung Electronics Co., Ltd., Suwon-si (KR)

(21) Appl. No.: 14/160,493

(22) Filed: Jan. 21, 2014

Related U.S. Application Data
(60) Provisional application No. 61/757,664, filed on Jan. 28, 2013.
(60) Provisional application No. 61/757,659, filed on Jan. 28, 2013.

(51) Int. Cl. G06F 3/0484; G06F 3/0488; G06F 3/0485

(52) U.S. Cl. CPC G06F 3/04842; G06F 3/04855; G06F 3/04847; G06F 3/0488
USPC 715/771

(57) ABSTRACT

A computing system includes: a control unit configured to determine an entry type based on detecting an activation spot, determine an interface characteristic based on the entry type, provide a device content based on the interface characteristic, and a communication interface, coupled to the control unit, configured to communicate the device content for presenting on a device.

### CROSS-REFERENCE TO RELATED APPLICATION(S)

This application claims the benefit of U.S. Provisional Patent Application Ser. No. 61/757,659 filed Jan. 28, 2013, and the subject matter thereof is incorporated herein by reference thereto.

This application claims the benefit of U.S. Provisional Patent Application Ser. No. 61/757,664 filed Jan. 28, 2013, and the subject matter thereof is incorporated herein by reference thereto.

### TECHNICAL FIELD

An embodiment of the present invention relates generally to a computing system, and more particularly to a system for content access mechanism.

### BACKGROUND

Modem portable consumer and industrial electronics, especially client devices such as navigation systems, cellular phones, portable digital assistants, and combination devices are providing increasing levels of functionality to support modem life including location-based information services. Research and development in the existing technologies can take a myriad of different directions.

As users become more empowered with the growth of mobile location based service devices, new and old paradigms begin to take advantage of this new device space. There are many technological solutions to take advantage of this new device location opportunity. One existing approach is to use location information to provide personalized content through a mobile device, such as a cell phone, smart phone, or a personal digital assistant.

Personalized content services allow users to create, transfer, store, and/or consume information in order for users to create, transfer, store, and consume in the “real world.” One such use of personalized content services is to efficiently transfer or guide users to the desired product or service.

Computing system and personalized content services enabled systems have been incorporated in automobiles, notebooks, handheld devices, and other portable products. Today, these systems aid users by incorporating available, real-time relevant information, such as advertisement, entertainment, local businesses, or other points of interest (POI).

Thus, a need still remains for a computing system with content access mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### SUMMARY

An embodiment of the present invention provides a computing system including: a control unit configured to determine an entry type based on detecting an activation spot, determine an interface characteristic based on the entry type, provide a device content based on the interface characteristic, and a communication interface, coupled to the control unit, configured to communicate the device content for presenting on a device.

An embodiment of the present invention provides a method of operation of a computing system including: determining an entry type based on detecting an activation spot; determining an interface characteristic based on the entry type; and providing a device content based on the interface characteristic for presenting on a device.

An embodiment of the present invention provides a computing having a user interface including: a contact region configured to detect an activation spot; and a content preview configured to overlap the contact region based on a gesture direction of a user entry.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with content access mechanism in an embodiment of the present invention.

FIG. 2 is first examples of a display interface of the first device.

FIG. 3 is second examples of a display interface of the first device.

FIG. 4 is third examples of a display interface of the first device.

FIG. 5 is fourth examples of a display interface of the first device.

FIG. 6 is an exemplary block diagram of the computing system.

FIG. 7 is a control flow of the computing system.

### DETAILED DESCRIPTION

The following embodiments of the present invention determine an entry type based on detecting an activation spot. The entry type is used to determine an interface characteristic to change a coloration gradient of a device content. As a result, a device interface can present the device content having various instances of the interface characteristic based on the entry type received.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “relevant information” referred to herein includes the navigation information described as well as information relating to points of interest to the user, such as local business, hours of businesses, types of businesses, advertised specials, traffic information, maps, local events, and nearby community or personal information.

The term “module” referred to herein can include software, hardware, or a combination thereof in the embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

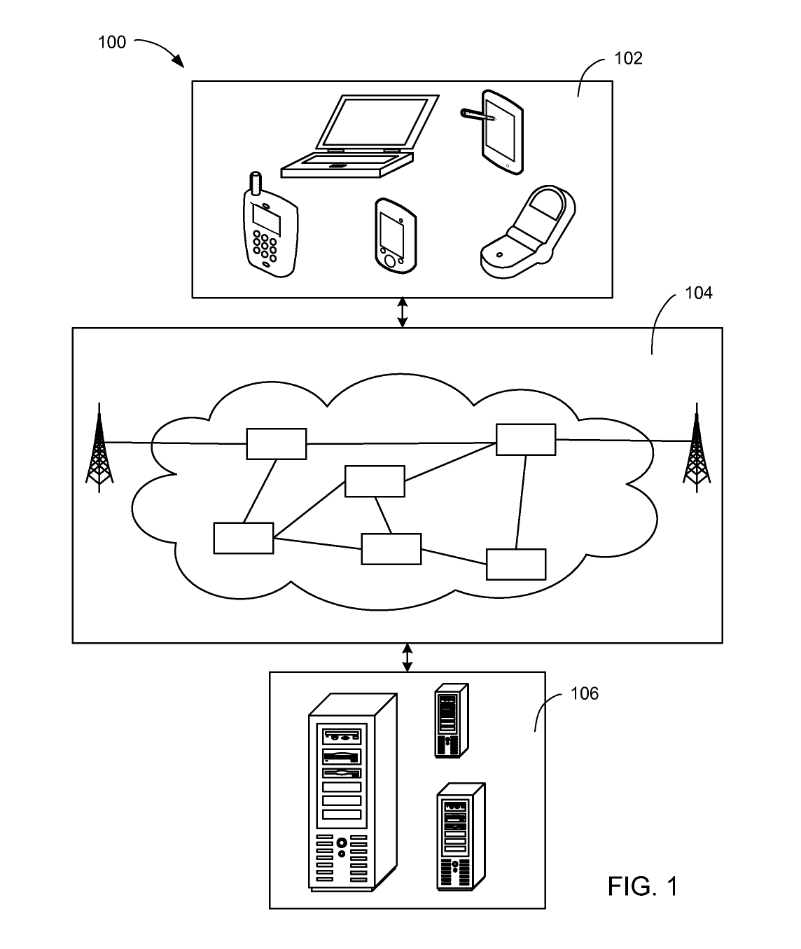

Referring now to FIG. 1, therein is shown a computing system 100 with content access mechanism in an embodiment of the present invention. The computing system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, wearable digital device, tablet, notebook computer, television (TV), automotive telematic communication system, or other multi-functional mobile communication or entertainment device. The first device 102 can be a standalone device, or can be incorporated with a vehicle, for example a car, truck, bus, aircraft, boat/vessel, or train. The first device 102 can couple to the communication path 104 to communicate with the second device 106.

For illustrative purposes, the computing system 100 is described with the first device 102 as a display device, although it is understood that the first device 102 can be different types of devices. For example, the first device 102 can also be a non-mobile computing device, such as a server, a server farm, or a desktop computer.

The second device 106 can be any of a variety of centralized or decentralized computing devices. For example, the second device 106 can be a computer, grid computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102. The second device 106 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Android™ smartphone, or Windows™ platform smartphone.

For illustrative purposes, the computing system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, aircraft, boat/vessel, or train.

Also for illustrative purposes, the computing system 100 is shown with the second device 106 and the first device 102 as end points of the communication path 104, although it is understood that the computing system 100 can have a different partition between the first device 102, the second device 106, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, wireless High-Definition Multimedia Interface (HDMI), Near Field Communication (NFC), Infrared Data Association standard (IrDA), wireless fidelity (WiFi), and worldwide interoperability for microwave access (WiMAX) are examples of wireless communication that can be included in the communication path 104. Ethernet, HDMI, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

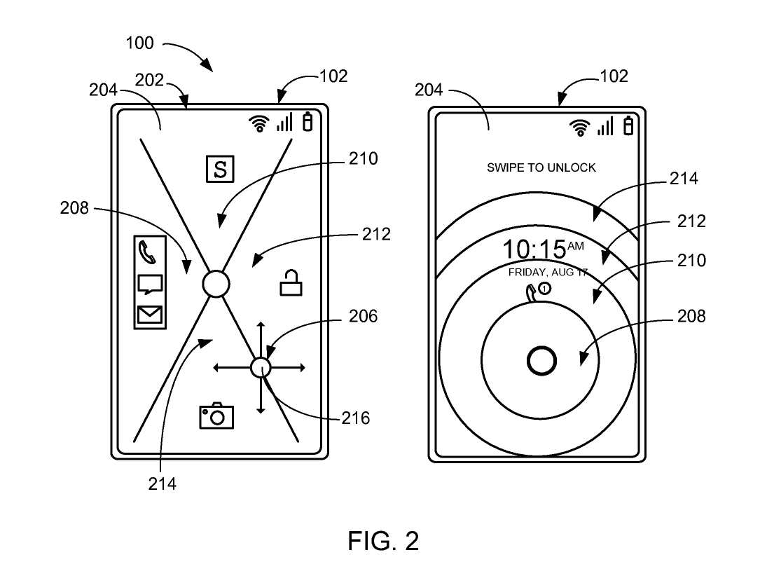

Referring now to FIG. 2, therein is shown first examples of a display interface 202 of the first device 102. For clarity and brevity, the discussion of the present invention will focus on the first device 102 displaying the result generated by the computing system 100. However, the second device 106 of FIG. 1 and the first device 102 can be discussed interchangeably.

The display interface 202 is a surface of the first device 102 for interacting with the first device 102. The display interface 202 can include a contact region 204. The contact region 204 is an area within the display interface 202. For example, the contact region 204 can represent the area where a user entry 206 is made. The user entry 206 is a manner of interacting with the first device 102. Details regarding the user entry 206 will be discussed below.

The contact region 204 can include a first sub-region 208, a second sub-region 210, a third sub-region 212, a fourth sub-region 214, or a combination thereof. The first sub-region 208, the second sub-region 210, the third sub-region 212, the fourth sub-region 214, or a combination thereof is subarea of the contact region 204. For example, the shape of the first sub-region 208, the second sub-region 210, the third sub-region 212, and the fourth sub-region 214 can represent a polygon, circle, or a combination thereof. For further example, the contact region 204 can be divided into quadrants represented as the first sub-region 208, the second sub-region 210, the third sub-region 212, and the fourth sub-region 214.

The display interface 202 can detect an activation spot 216. The activation spot 216 is a location on the display interface 202 where the user entry 206 is detected. For example, the activation spot 216 can be detected on the contact region 204 representing the first sub-region 208.

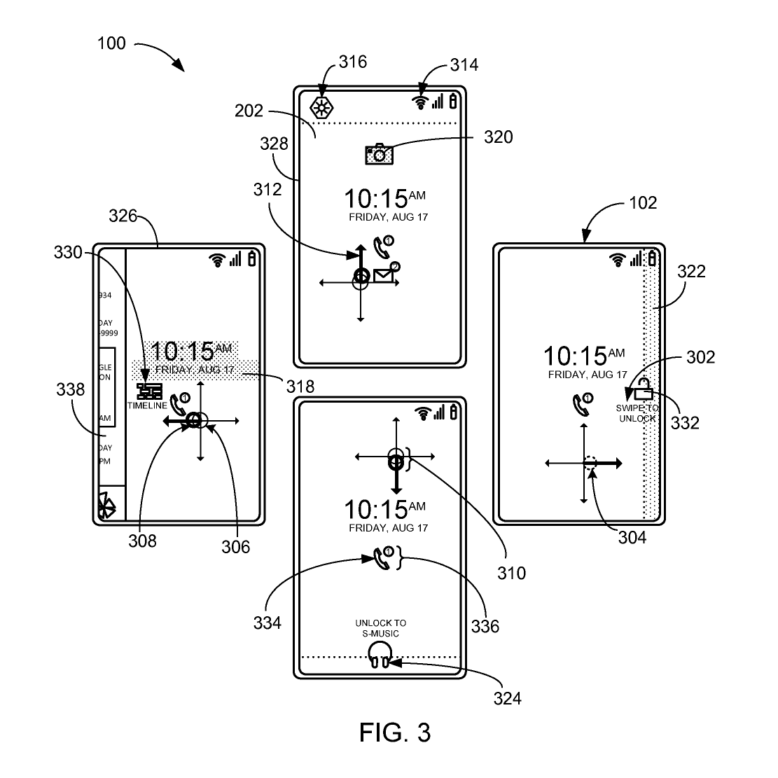

Referring now to FIG. 3, therein is shown second examples of the display interface 202 of the first device 102. An entry type 302 is a classification of the user entry 206 of FIG. 2. For example, the entry type 302 can include a swipe, a long press, a scrub, a scroll, a tilt, or a combination thereof. More specifically, the swipe can represent the user's finger contacting the display interface 202 in one direction with a gesture duration 304 of less than 0.5 second from an initial spot 306 to a subsequent spot 308. The long press can represent the user's finger contacting the display interface 202 in one location with the gesture duration 304 of greater than 1 second. The scrub can represent the user's finger contacting the display interface 202 in one direction with the gesture duration 304 of greater than 0.5 second from the initial spot 306 to the subsequent spot 308. The scroll and the tilt will be discussed below.

The initial spot 306 is a location on the display interface 202 where the activation spot 216 of FIG. 2 is first detected. The subsequent spot 308 is a location on the display interface 202 where the activation spot 216 is last detected. The gesture duration 304 is a time length of the user entry 206 making contact with the display interface 202. A gesture speed 310 is a rate of moving from the initial spot 306 to the subsequent spot 308. A gesture direction 312 is a path taken by the user entry 206 contacting the display interface 202. For example, the gesture direction 312 can represent from the left extent to the right extent of the display interface 202.

The display interface 202 can have an interface characteristic 314. The interface characteristic 314 is an attribute of the display interface 202. For example, the interface characteristic 314 can include a coloration gradient 316. The coloration gradient 316 is a color pattern and luminosity level. For example, the coloration gradient 316 can include the brightness level, the hue level, or a combination thereof.

The coloration gradient 316 can include an interface coloration 318, a content coloration 320, an edge coloration 322, or a combination thereof. The interface coloration 318 is the color pattern and luminosity level of the display interface 202. The content coloration 320 is the color pattern and luminosity level of a device content 324. The edge coloration 322 is the color pattern and luminosity level of a short display side 326, a long display side 328, or a combination thereof.

The device content 324 is information displayed on the display interface 202. For example, the device content 324 can represent an application running on the first device 102. For a different example, the device content 324 can represent a destination indicator 330. The destination indicator 330 is an icon for the application running on the first device 102. For example, the destination indicator 330 can include an icon for “Timeline,” “Camera,” “Music,” or a combination thereof. For further example, the destination indicator 330 can represent a lock state 332. The lock state 332 is a condition indicating an accessibility. For example, the lock state 332 can represent “lock” or “unlock” for accessing the first device 102, the device content 324, or a combination thereof. For further example, the device content 324 can represent a lock screen as indicated by the lock state 332 of “lock.”

A display location 334 is a position on the display interface 202 to display the device content 324. The device content 324 can have a content size 336. The content size 336 is a dimension of how large or small the device content 324 is. For example, the computing system 100 can change the content size of the device content 324.

The device content 324 can include a content preview 338, which is a brief showing of the device content 324. More specifically, the content preview 338 can represent what the display interface 202 can present if the user were to select the destination indicator 330. For example, the user can make the user entry 206 of scrub on the contact region 204 with the gesture direction 312 from left to right of the display interface 202.

The computing system 100 can present the content preview 338 in reaction to the user entry 206 by disclosing the content preview 338 gradually from the left extent towards the right extent of the display interface 202. More specifically, the right extent of the content preview 206 can be maintained as the activation spot 216 where the user's finger can remain in contact with the display interface 202 as the finger scrubs across the display interface 202. As the finger scrubs across the display interface 202, the content preview 338 can overlap the contact region 204.

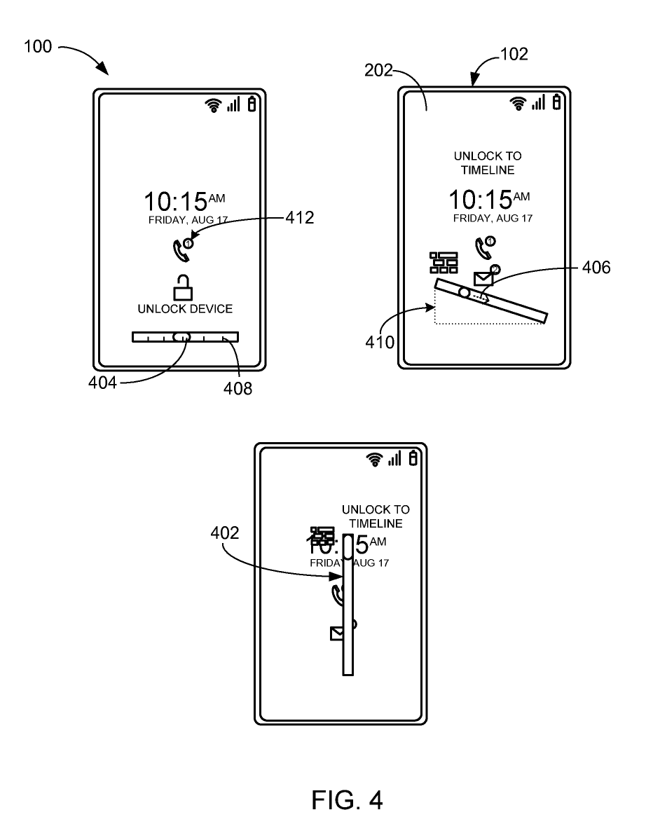

Referring now to FIG. 4, therein is shown third examples of the display interface 202 of the first device 102. The display interface 202 can display a scrollbar 402. The scrollbar 402 is a device content 324 of FIG. 3 to control the display interface 202. For example, the user entry 206 of FIG. 2 can scroll the presentation of the device content 324 by moving a bar cursor 404 on the scrollbar 402.

The bar cursor 404 is a marker on the scrollbar 402 to control the presentation on the display interface 202. For example, the user entry 206 can control the display of the device content 324, such as the destination indicator 330 of FIG. 3, by moving the bar cursor 404 along the scrollbar 402. A cursor direction 406 is a path taken by the bar cursor 404 along the scrollbar 402. A bar position 408 is a location on the scrollbar 402. For example, the by moving the bar cursor 404 to the bar position 408, the computing system 100 can trigger a display of the device content 324.

A bar orientation 410 is a slant level of the scrollbar 402. For example, the bar orientation 410 can represent the scrollbar 402 being parallel or perpendicular to the short display side 326 of FIG. 3 or the long display side 328 of FIG. 3. For another example, the bar orientation 410 can represent the scrollbar 402 having the slant level between 0 to 180 degrees relative to the short display side 326, the long display side 328, or a combination thereof.

A device response 412 is a feedback by the first device 102. For example, the first device 102 can provide the device response 412 representing a tactile response, a sound response, a visual response, or a combination thereof. For example, the device response 412 can represent a vibration when the bar cursor 404 moves along the scrollbar 402. For further example, the device response 412 can represent a sound response when the activation spot 216 of FIG. 2 changes from the initial spot 306 of FIG. 3 to the subsequent spot 308 of FIG. 3.

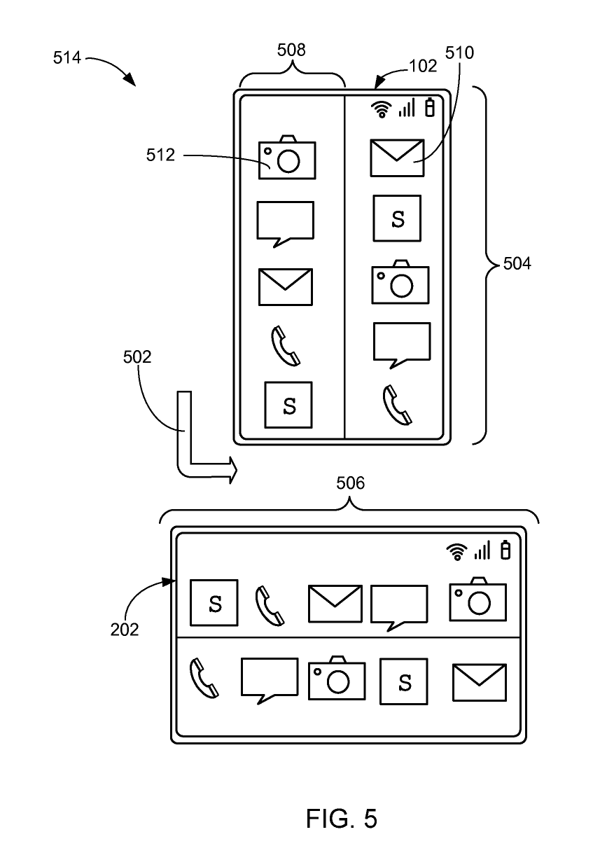

Referring now to FIG. 5, therein is shown fourth examples of the display interface 202 of the first device 102. A device orientation 502 is a slant level of the first device 102. For example, the device orientation 502 can include a vertical mode 504 and a horizontal mode 506. The vertical mode 504 is having the short display side 326 of FIG. 3 as a top and bottom extent of the first device 102. The horizontal mode 506 is having the long display side 328 of FIG. 3 as a top and bottom extent of the first device 102. The user entry 206 of FIG. 2 can represent a tilt to change the device orientation 502 from the vertical mode 504 to the horizontal mode 506 or vice versa.

The display interface 202 can display a content lane 508. The content lane 508 is a section of the display interface 202 running from one extent to another extent of the display interface 202. For example, the display interface 202 can have two instances of the content lane 508 sectioned off from the top extent to the bottom extent of the display interface 202. More specifically, one instance of the content lane 508 can display the device content 324 of FIG. 3 based on a use context 514 representing a use frequency 510 and another instance of the content lane 508 can display the device content 324 based on the use context 514 representing a use timing 512.

The use context 514 is a situation, circumstance, or a combination thereof surrounding the first device 102. For example, the use context 514 can represent where the user is using the computing system 100. For example, the use context 514 can represent the time of day the user is using the computing system 100. The use frequency 510 is a rate of accessing the device content 324. For example, the use frequency 510 can represent that the device content 324 representing email application as the most frequently used. The use timing 512 is a date or time of when the device content 324 was last accessed. For example, the use timing 512 can represent that the device content 324 of “camera” was the device content 324 last accessed.

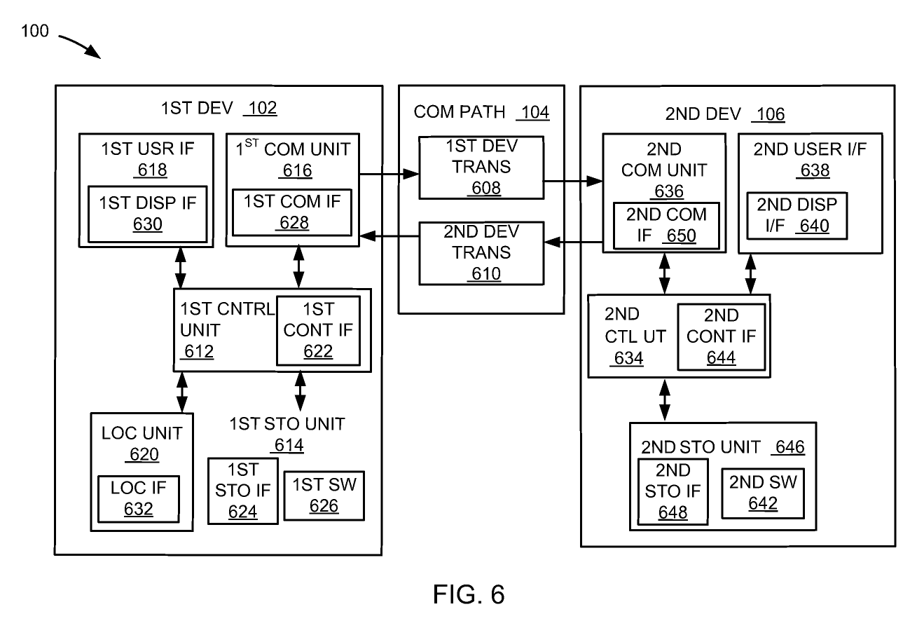

Referring now to FIG. 6, therein is shown an exemplary block diagram of the computing system 100. The computing system 100 can include the first device 102, the communication path 104, and the second device 106. The first device 102 can send information in a first device transmission 608 over the communication path 104 to the second device 106. The second device 106 can send information in a second device transmission 610 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of the present invention.

The first device 102 can include a first control unit 612, a first storage unit 614, a first communication unit 616, a first user interface 618, and a location unit 620. The first control unit 612 can include a first control interface 622. The first control unit 612 can execute a first software 626 to provide the intelligence of the computing system 100.

The first control unit 612 can be implemented in a number of different manners. For example, the first control unit 612 can be a processor, an application specific integrated circuit (ASIC) an embedded processor, a microprocessor, a hardware control logic, a hardware finite state machine (FSM), a digital signal processor (DSP), or a combination thereof. The first control interface 622 can be used for communication between the first control unit 612 and other functional units in the first device 102. The first control interface 622 can also be used for communication that is external to the first device 102.

The first control interface 622 can receive information from the other functional units or from external sources, or can transmit information to the other functional units or to external destinations. The external sources and the external destinations refer to sources and destinations physically separate from to the first device 102.

The first control interface 622 can be implemented in different ways and can include different implementations depending on which functional units or external units are being interfaced with the first control interface 622. For example, the first control interface 622 can be implemented with a pressure sensor, an inertial sensor, a microelectromechanical system (MEMS), optical circuitry, waveguides, wireless circuitry, wireline circuitry, or a combination thereof.

The location unit 620 can generate location information, current heading, and current speed of the first device 102, as examples. The location unit 620 can be implemented in many ways. For example, the location unit 620 can function as at least a part of a global positioning system (GPS), an inertial navigation system, a cellular-tower location system, a pressure location system, or any combination thereof.

The location unit 620 can include a location interface 632. The location interface 632 can be used for communication between the location unit 620 and other functional units in the first device 102. The location interface 632 can also be used for communication that is external to the first device 102.

The location interface 632 can receive information from the other functional units or from external sources, or can transmit information to the other functional units or to external destinations. The external sources and the external destinations refer to sources and destinations physically separate from the first device 102.

The location interface 632 can include different implementations depending on which functional units or external units are being interfaced with the location unit 620. The location interface 632 can be implemented with technologies and techniques similar to the implementation of the first control interface 622.

The first storage unit 614 can store the first software 626. The first storage unit 614 can also store the relevant information, such as advertisements, points of interest (POI), navigation routing entries, or any combination thereof. The relevant information can also include news, media, events, or a combination thereof from the third party content provider.

The first storage unit 614 can be a volatile memory, a nonvolatile memory, an internal memory, an external memory, or a combination thereof. For example, the first storage unit 614 can be a nonvolatile storage such as non-volatile random access memory (NVRAM), Flash memory, disk storage, or a volatile storage such as static random access memory (SRAM).

The first storage unit 614 can include a first storage interface 624. The first storage interface 624 can be used for communication between and other functional units in the first device 102. The first storage interface 624 can also be used for communication that is external to the first device 102.

The first storage interface 624 can receive information from the other functional units or from external sources, or can transmit information to the other functional units or to external destinations. The external sources and the external destinations refer to sources and destinations physically separate from the first device 102.

The first storage interface 624 can include different implementations depending on which functional units or external units are being interfaced with the first storage unit 614. The first storage interface 624 can be implemented with technologies and techniques similar to the implementation of the first control interface 622.

The first communication unit 616 can enable external communication to and from the first device 102. For example, the first communication unit 616 can permit the first device 102 to communicate with the second device 106 of FIG. 1, an attachment, such as a peripheral device or a computer desktop, and the communication path 104.

The first communication unit 616 can also function as a communication hub allowing the first device 102 to function as part of the communication path 104 and not limited to be an end point or terminal unit to the communication path 104. The first communication unit 616 can include active and passive components, such as microelectronics or an antenna, for interaction with the communication path 104.

The first communication unit 616 can include a first communication interface 628. The first communication interface 628 can be used for communication between the first communication unit 616 and other functional units in the first device 102. The first communication interface 628 can receive information from the other functional units or can transmit information to the other functional units.

The first communication interface 628 can include different implementations depending on which functional units are being interfaced with the first communication unit 616. The first communication interface 628 can be implemented with technologies and techniques similar to the implementation of the first control interface 622.

The first user interface 618 allows a user (not shown) to interface and interact with the first device 102. The first user interface 618 can include an input device and an output device. Examples of the input device of the first user interface 618 can include a keypad, a touchpad, soft-keys, a keyboard, a microphone, an infrared sensor for receiving remote signals, or any combination thereof to provide data and communication inputs.

The first user interface 618 can include a first display interface 630. The first display interface 630 can include a display, a projector, a video screen, a speaker, or any combination thereof.

The first control unit 612 can operate the first user interface 618 to display information generated by the computing system 100. The first control unit 612 can also execute the first software 626 for the other functions of the computing system 100, including receiving location information from the location unit 620. The first control unit 612 can further execute the first software 626 for interaction with the communication path 104 via the first communication unit 616.

The second device 106 can be optimized for implementing the embodiment of the present invention in a multiple device embodiment with the first device 102. The second device 106 can provide the additional or higher performance processing power compared to the first device 102. The second device 106 can include a second control unit 634, a second communication unit 636, and a second user interface 638.

The second user interface 638 allows a user (not shown) to interface and interact with the second device 106. The second user interface 638 can include an input device and an output device. Examples of the input device of the second user interface 638 can include a keypad, a touchpad, soft-keys, a keyboard, a microphone, or any combination thereof to provide data and communication inputs. Examples of the output device of the second user interface 638 can include a second display interface 640. The second display interface 640 can include a display, a projector, a video screen, a speaker, or any combination thereof.

The second control unit 634 can execute a second software 642 to provide the intelligence of the second device 106 of the computing system 100. The second software 642 can operate in conjunction with the first software 626. The second control unit 634 can provide additional performance compared to the first control unit 612.

The second control unit 634 can operate the second user interface 638 to display information. The second control unit 634 can also execute the second software 642 for the other functions of the computing system 100, including operating the second communication unit 636 to communicate with the first device 102 over the communication path 104.

The second control unit 634 can be implemented in a number of different manners. For example, the second control unit 634 can be a processor, an embedded processor, a microprocessor, hardware control logic, a hardware finite state machine (FSM), a digital signal processor (DSP), or a combination thereof.

The second control unit 634 can include a second control interface 644. The second control interface 644 can be used for communication between the second control unit 634 and other functional units in the second device 106. The second control interface 644 can also be used for communication that is external to the second device 106.

The second control interface 644 can receive information from the other functional units or from external sources, or can transmit information to the other functional units or to external destinations. The external sources and the external destinations refer to sources and destinations physically separate from the second device 106.

The second control interface 644 can be implemented in different ways and can include different implementations depending on which functional units or external units are being interfaced with the second control interface 644. For example, the second control interface 644 can be implemented with a pressure sensor, an inertial sensor, a microelectromechanical system (MEMS), optical circuitry, waveguides, wireless circuitry, wireline circuitry, or a combination thereof.

A second storage unit 646 can store the second software 642. The second storage unit 646 can also store the relevant information, such as advertisements, points of interest (POI), navigation routing entries, or any combination thereof. The second storage unit 646 can be sized to provide the additional storage capacity to supplement the first storage unit 614.

For illustrative purposes, the second storage unit 646 is shown as a single element, although it is understood that the second storage unit 646 can be a distribution of storage elements. Also for illustrative purposes, the computing system 100 is shown with the second storage unit 646 as a single hierarchy storage system, although it is understood that the computing system 100 can have the second storage unit 646 in a different configuration. For example, the second storage unit 646 can be formed with different storage technologies forming a memory hierarchal system including different levels of caching, main memory, rotating media, or off-line storage.

The second storage unit 646 can be a volatile memory, a nonvolatile memory, an internal memory, an external memory, or a combination thereof. For example, the second storage unit 646 can be a nonvolatile storage such as non-volatile random access memory (NVRAM), Flash memory, disk storage, or a volatile storage such as static random access memory (SRAM).

The second storage unit 646 can include a second storage interface 648. The second storage interface 648 can be used for communication between other functional units in the second device 106. The second storage interface 648 can also be used for communication that is external to the second device 106.

The second storage interface 648 can receive information from the other functional units or from external sources, or can transmit information to the other functional units or to external destinations. The external sources and the external destinations refer to sources and destinations physically separate from the second device 106.

The second storage interface 648 can include different implementations depending on which functional units or external units are being interfaced with the second storage unit 646. The second storage interface 648 can be implemented with technologies and techniques similar to the implementation of the second control interface 644.

The second communication unit 636 can enable external communication to and from the second device 106. For example, the second communication unit 636 can permit the second device 106 to communicate with the first device 102 over the communication path 104.

The second communication unit 636 can also function as a communication hub allowing the second device 106 to function as part of the communication path 104 and not limited to be an end point or terminal unit to the communication path 104. The second communication unit 636 can include active and passive components, such as microelectronics or an antenna, for interaction with the communication path 104.

The second communication unit 636 can include a second communication interface 650. The second communication interface 650 can be used for communication between the second communication unit 636 and other functional units in the second device 106. The second communication interface 650 can receive information from the other functional units or can transmit information to the other functional units.

The second communication interface 650 can include different implementations depending on which functional units are being interfaced with the second communication unit 636. The second communication interface 650 can be implemented with technologies and techniques similar to the implementation of the second control interface 644.

The first communication unit 616 can couple with the communication path 104 to send information to the second device 106 in the first device transmission 608. The second device 106 can receive information in the second communication unit 636 from the first device transmission 608 of the communication path 104.

The second communication unit 636 can couple with the communication path 104 to send information to the first device 102 in the second device transmission 610. The first device 102 can receive information in the first communication unit 616 from the second device transmission 610 of the communication path 104. The computing system 100 can be executed by the first control unit 612, the second control unit 634, or a combination thereof. For illustrative purposes, the second device 106 is shown with the partition having the second user interface 638, the second storage unit 646, the second control unit 634, and the second communication unit 636, although it is understood that the second device 106 can have a different partition. For example, the second software 642 can be partitioned differently such that some or all of its function can be in the second control unit 634 and the second communication unit 636. Also, the second device 106 can include other functional units not shown in FIG. 6 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100. For example, the first device 102 is described to operate the location unit 620, although it is understood that the second device 102 can also operate the location unit 620.

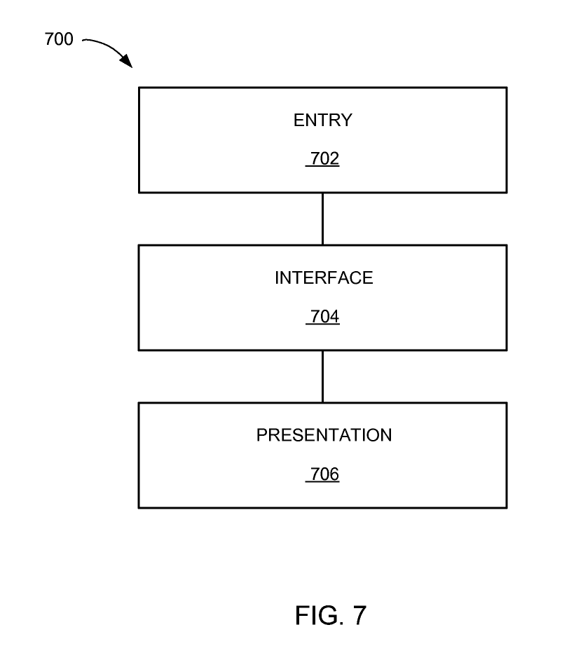

Referring now to FIG. 7, therein is shown a control flow 700 of the computing system 100 of FIG. 1. The computing system 100 can include an entry module 702. The entry module 702 determines the entry type 302 of FIG. 3. For example, the entry module 702 can determine the entry type 302 of the user entry 206 of FIG. 2.

The entry module 702 can determine the entry type 302 in a number of ways. For example, the entry module 702 can determine the entry type 302 based on the user entry 206 representing a swipe, a long press, a scrub, a scroll, a tilt, or a combination thereof as discussed above. For further example, the entry module 702 can determine the entry type 302 based on the contact region 204 of FIG. 2, the gesture direction 312 of FIG. 3, the gesture speed 310 of FIG. 3, the gesture duration 304 of FIG. 3, the device orientation 502 of FIG. 5, or a combination thereof.

For a specific example, the entry module 702 can determine the contact region 204 of the first device 102 of FIG. 2. More specifically, the entry module 702 can determine the contact region 204 of where the user entry 206 is made on the display interface 202 of FIG. 2. For example, the contact region 204 can include the first sub-region 208 of FIG. 2, the second sub-region 210 of FIG. 2, the third sub-region 212 of FIG. 2, the fourth sub-region 214 of FIG. 2, or a combination thereof. The entry module 702 can determine the contact region 204 based on detecting the activation spot 216 of FIG. 2 triggered by the user entry 206 contacting the first sub-region 208, the second sub-region 210, the third sub-region 212, the fourth sub-region 214, or a combination thereof.

For another example, the entry module 702 can determine the gesture direction 312. More specifically, the entry module 702 can determine the gesture direction 312 based on the cardinal direction relative to the first device 102. For example, the top extent of the first device 102 can represent the North or 0 degree. The right extent of the first device 102 can represent the East or 90 degrees. The bottom extent of the first device 102 can represent South or 180 degrees. The left extent of the first device 102 can represent West or 270 degrees.

For further example, the contact region 204 of the first device 102 can have 4 triangular regions relative to the activation spot 216 where the user entry 206 made contact to the display interface 202. Moreover, the 4 triangular regions of the contact region 204 can represent the first sub-region 208, the second sub-region 210, the third sub-region 212, and the fourth sub-region 214. Furthermore, the first sub-region 208 can represent 45 degrees to −45 degrees, the second sub-region 210 can represent 45 degrees to 135 degrees, the third sub-region 212 can represent 135 degrees to 225 degrees, and the fourth sub-region 214 can represent 225 degrees to 315 degrees, all from the activation spot 216.

The entry module 702 can determine the gesture direction 312 by detecting the activation spot 216 move along the display interface 202 from the initial spot 306 of FIG. 3 to the subsequent spot 308 of FIG. 3 according to the cardinal direction. For another example, the entry module 702 can determine the gesture direction 312 based on detecting the activation spot 216 change within the contact region 204. For a specific example, the entry module 702 can determine the gesture direction 312 based on detecting the activation spot 216 change from the first sub-region 208 to the second sub-region 210.

For another example, the entry module 702 can determine the gesture speed 310 of the user entry 206. The entry module 702 can determine the gesture speed 310 based on how fast the activation spot 216 changes within display interface 202. As an example, the entry module 702 can determine the gesture speed 310 based on the activation spot 216 change within the contact region 204, such as from the first sub-region 208 to the fourth sub-region 214. Moreover, the entry module 702 can determine the gesture speed 310 based on the activation spot 216 changing from the initial spot 306 to the subsequent spot 308 by taking greater, equal to, or less than 1 second.

For another example, the entry module 702 can determine the gesture duration 304. More specifically, the entry module 702 can determine the gesture duration 304 based on a length of time the activation spot 216 remained detected on the display interface 202. For example, the entry module 702 can determine the gesture duration 304 based on the activation spot 216 remained detected on the initial spot 306 for greater than 1 second. For another example, the entry module 702 can determine the gesture duration 304 based on the activation spot 216 remained detected on the initial spot 306 for less than 1 second prior to the activation spot 216 being changed to the subsequent spot 308.

For another example, the entry module 702 can determine the device orientation 502. More specifically, the entry module 702 can determine the device orientation 502 of whether first device 102 is oriented as the vertical mode 504 of FIG. 5 or the horizontal mode 506 of FIG. 5. For example, the entry module 702 can determine the device orientation 502 of the vertical mode 504 with the gyroscope of the first device 102 detecting the short display side 326 of FIG. 3 as the top extent of the first device 102. In contrast, the entry module 702 can determine the device orientation 502 of the horizontal mode 506 with the gyroscope of the first device 102 detecting the long display side 328 of FIG. 3 as the top extent of the first device 102.

The entry module 702 can determine the entry type 302 based on based on the contact region 204, the gesture direction 312, the gesture speed 310, the gesture duration 304, the device orientation 502, or a combination thereof. For example, the entry module 702 can determine the entry type 302 to represent a long press based on the contact region 204, the gesture duration 304, or a combination thereof. More specifically, the entry type 302 can represent the long press because the entry module 702 determined the activation spot 216 remained unchanged in the contact region 204 for the gesture duration 304 greater than 1 second.

For a different example, the entry module 702 can determine the entry type 302 to represent the swipe based on the gesture direction 312, the gesture speed 310, and the contact region 204. More specifically, the gesture direction 312 can represent the activation spot 216 changing from the first sub-region 208 to the third sub-region 212. Furthermore, the gesture speed 310 can be less than 1 second for the activation spot 216 changing from the initial spot 306 to the subsequent spot 308. As a result, the entry module 702 can determine the entry type 302 to represent a swipe from the first sub-region 208 to the third sub-region 212. In contrast, the entry module 702 can determine the entry type 302 to represent a scrub if the gesture speed 310 can be greater than 1 second.

For another example, the entry module 702 can determine the entry type 302 to represent a tilt based on the device orientation 502. For example, the device orientation 502 can represent the vertical mode 504 initially. The user entry 206 can represent the user changing the device orientation 502 to the horizontal mode 506. As a result, the entry module 702 can determine the entry type 302 to represent the tilt. The entry module 702 can communicate the entry type 302 to an interface module 704.

The computing system 100 can include the interface module 704, which can couple to the entry module 702. The interface module 704 determines the interface characteristic 314 of FIG. 3. For example, the interface module 704 can determine the interface characteristic 314 based on the entry type 302.

The interface module 704 can determine the interface characteristic 314 in a number of ways. For example, the interface module 704 can determine the coloration gradient 316 of FIG. 3 based on the entry type 302. More specifically, the interface module 704 can determine the coloration gradient 316 based on the gesture direction 312, the contact region 204, or a combination thereof.

For a specific example, the interface module 704 can determine the coloration gradient 316 of the contact region 204 where the activation spot 216 is detected to have the interface coloration 318 of FIG. 3 to be different from the contact region 204 where the activation spot 216 is not detected. As an example, the activation spot 216 can be detected on the first sub-region 208. The interface module 704 can determine the coloration gradient 316 of the interface coloration 318 to be brighter, different in color, or a combination thereof than the second sub-region 210, the third sub-region 212, the fourth sub-region 214, or a combination thereof.

For further example, the interface module 704 can determine the coloration gradient 316 of the content coloration 320 of FIG. 3 based on the entry type 302. More specifically, the interface module 704 can determine the coloration gradient 316 of the content coloration 320 to be different based on the entry type 302. As an example, the activation spot 216 can be detected in the second sub-region 210. The interface module 704 can determine the coloration gradient 316 of the content coloration 320 within the second sub-region 210 to be brighter, different in color, or a combination thereof than the content coloration 320 within the first sub-region 208, the third sub-region 212, the fourth sub-region 214, or a combination thereof.

For further example, the interface module 704 can determine the coloration gradient 316 of the edge coloration 322 of FIG. 3 based on the entry type 302. More specifically, the interface module 704 can determine the coloration gradient 316 of the edge coloration 322 to be different based on the entry type 302. As an example, the activation spot 216 can be detected in the third sub-region 212. The interface module 704 can determine the coloration gradient 316 of the edge coloration 322 for the right extent of the display interface 202 to be brighter, different in color, or a combination thereof than the edge coloration 322 of other extents of the display interface 202.

For further example, the interface module 704 can change the coloration gradient 316 of the interface coloration 318, the content coloration 320, the edge coloration 322, or a combination thereof based on the gesture direction 312. More specifically, the interface module 704 can increase the coloration gradient 316 as the activation spot 216 changes towards the particular instance of the contact region 204. For example, the activation spot 216 can be in the center of the display interface 202. The user entry 206 can change the activation spot 216 from the center towards the left extent of the display interface 202. The interface module 704 can change the coloration gradient 316 by increasing the coloration gradient 316 of the interface coloration 318 of the fourth sub-region 214, the content coloration 320 within the fourth sub-region 214, and the edge coloration of the left extent of the display interface 202, or a combination thereof. In contrast, the interface module 704 can decrease the coloration gradient 316 if the gesture direction 312 changes the activation spot 216 away from the particular instance of the contact region 204.

For further example, the interface module 704 can determine the destination indicator 330 of FIG. 3 based on the contact region 204, the gesture direction 312, or a combination thereof. More specifically, the initial spot 306 can represent the activation spot 216 in the center of the display interface 202. The gesture direction 312 can represent the user changing the activation spot 216 from the center to towards the bottom extent of the display interface 202. Stated differently, the gesture direction 312 can represent the activation spot 216 being detected is changed from the center of the display interface 202 to the fourth sub-region 214. Based on the contact region 204 and the gesture direction 312 of the user entry 206, the interface module 704 can determine the destination indicator 330 to be displayed on the display interface 202.

For further example, the interface module 704 can determine the content size 336 of FIG. 3 based on the contact region 204, the gesture direction 312, or a combination thereof. More specifically, the initial spot 306 can represent the activation spot 216 in the center of the display interface 202. The gesture direction 312 can represent the user changing the activation spot 216 from the center to towards the right extent of the display interface 202. Stated differently, the gesture direction 312 can represent the activation spot 216 being detected is changed from the center of the display interface 202 to the second sub-region 210. Based on the contact region 204 and the gesture direction 312 of the user entry 206, the interface module 704 can determine the content size 336 of the destination indicator 330 to be displayed on the display interface 202.

Furthermore, the interface module 704 can change the content size 336 gradually based on the contact region 204 where the activation spot 216 is detected, the gesture direction 312, or a combination thereof. For example, the initial spot 306 can represent the activation spot 216 being detected in the first sub-region 208. The gesture direction 312 can represent the activation spot 216 moving towards the second sub-region 210. Initially, the interface module 704 can determine the destination indicator 330 for the first sub-region 208 to be displayed. However, as the activation spot 216 changes from the first sub-region 208 to the second sub-region 210, the interface module 704 can gradually decrease the content size 336 of the destination indicator 330 for the first sub-region 208. In contrast, the interface module 704 can gradually increase the content size 336 of the destination indicator 330 in the second sub-region 210 as the activation spot 216 nears the second sub-region 210.

Furthermore, the interface module 704 can eliminate the destination indicator 330 based on the contact region 204, the gesture direction 312, or a combination thereof. Continuing with the pervious example, the interface module 704 can decrease the content size 336 as the activation spot 216 moves away from the particular instance of the contact region 204. Moreover, the interface module 704 can change the coloration gradient 316, the content size 336, or a combination thereof to eliminate the destination indicator 330 from being displayed on the display interface 202. More specifically, the interface module 704 can decrease the coloration gradient 316, the content size 336, or a combination thereof as the activation spot 216 moves away from the particular instance of the contact region 204. The interface module 704 can eliminate the destination indicator 330 from appearing on the display interface 202 once the activation spot 216 enters the different instance of the contact region 204.

For further example, the interface module 704 can determine the display location 334 of FIG. 3. More specifically, the interface module 704 can determine the display location 334 of the destination indicator 330 to be fixed on the display interface 202. As an example, no matter where the activation spot 216 is detected or the gesture direction 312 is heading towards, the interface module 704 can determine the display location 334 to represent the top extent of the display interface 202.

In contrast, the interface module 704 can determine the display location 334 to change based on the contact region 204, the gesture direction 312, or a combination thereof. More specifically, the interface module 704 can determine the display location 334 to be at the extent of the display interface 202 where the gesture direction 312 is heading towards. For a specific example, if the gesture direction 312 is heading towards the first sub-region 208 from the center of the display interface 202, the interface module 704 can determine the display location 334 to represent the left extent of the display interface 202 within the first sub-region 208.

For further example, the interface module 704 can determine the lock state 332 of FIG. 3 based on the entry type 302. As an example, the interface module 704 can determine the lock state 332 based on the device orientation 502. More specifically, the interface module 704 can determine the lock state 332 of locked or unlocked based on whether the device orientation 502 is in the vertical mode 504 or the horizontal mode 506. The interface module 704 can determine the lock state 332 to become unlocked when the device orientation 502 is changed from the vertical mode 504 to the horizontal mode 506.

For further example, the interface module 704 can change the contact region 204 based on the device orientation 502. More specifically, the interface module 704 can determine the contact region 204 to have 4 instances of contact region 204 represented as the first sub-region 208, the second sub-region 210, the third sub-region 212, the fourth sub-region 214, or a combination thereof. The interface module 704 can change the contact region 204 to have 2 instances of the contact region 204 represented as the first sub-region 208, the second sub-region 210, or a combination thereof when the device orientation 502 is changed from the vertical mode 504 to the horizontal mode 506. The interface module 704 can communicate the interface characteristic 314 to a presentation module 706.

The computing system 100 can include the presentation module 706, which can couple to the interface module 704. The presentation module 706 provides the device content 324 of FIG. 3. For example, the presentation module 706 can provide the device content 324 based on the interface characteristic 314, the entry type 302, or a combination thereof.

The presentation module 706 can provide the device content 324 in a number of ways. For example, the presentation module 706 can display the device content 324 representing the destination indicator 330 based on the interface characteristic 314. More specifically, the presentation module 706 can display the destination indicator 330 based on the coloration gradient 316, the content size 336, the display location 334, the lock state 332, or a combination thereof.

For example, the presentation module 706 can display the destination indicator 330 when the activation spot 216 reaches the particular instance of the contact region 204. The destination indicator 330 can represent the device content 324 representing “Timeline.” The device content 324 representing “Timeline” can be set for the first sub-region 208. The presentation module 706 can display the destination indicator 330 for “Timeline” when the activation spot 216 reaches the first sub-region 208.

Moreover, the presentation module 706 can display the destination indicator 330 for “Timeline” with the coloration gradient 316. For a specific example, the presentation module 706 can display the interface coloration 318 of the first sub-region 208 brighter or in different color than other instances of the contact region 204. The presentation module 706 can display the content coloration 320 of the destination indicator 330 brighter or in different color than other instances of the destination indicator 330. The presentation module 706 can display the edge coloration 322 of the left extent of the display interface 202 where the first sub-region 208 is located brighter or in different color than other extents of the display interface 202.

In contrast, the presentation module 706 can display the destination indicator 330 with the decreasing instance of the coloration gradient 316 when the activation spot 216 changes. More specifically, the presentation module 706 can display the interface coloration 318, the content coloration 320, the edge coloration 322, or a combination thereof with gradual decrease in the coloration gradient 316 as the gesture direction 312 is directed away from the destination indicator 330. As the gesture direction 312 nears another instance of the destination indicator 330, the presentation module 706 can no longer display the previous instance of the destination indicator 330 when the activation spot 216 is detected in the different instance of the contact region 204.

It has been discovered the computing system 100 displaying the destination indicator 330 with the coloration gradient 316 can improve the presentation of the device content 324. By dynamically changing the coloration gradient 316, the computing system 100 can improve the access to the device content 324. As a result, the computing system 100 can enhance the user experience of the first device 102, the computing system 100, or a combination thereof.

For further example, the presentation module 706 can display the destination indicator 330 with the content size 336. As discussed above, the content size 336 of the destination indicator 330 can gradually change based on the gesture direction 312 nears a particular instance of the contact region 204. The presentation module 706 can display the gradual increase in the content size 336 of the destination indicator 330 as the gesture direction 312 nears the particular instance of the contact region 204.

For further example, the presentation module 706 can display the destination indicator 330 based on the display location 334. As discussed above, the presentation module 706 can display the destination indicator 330 where the display location 334 is determined. For example, if the display location 334 is fixed, no matter where the activation spot 216 is detected, the presentation module 706 can display the destination indicator 330 at the display location 334. In contrast, if the display location 334 is dynamic, the presentation module 706 can display the destination indicator 330 at the same longitude, latitude, or a combination thereof where the activation spot 216 is detected. More specifically, the presentation module 706 can display the destination indicator 330 where the subsequent spot 308 is detected after the user entry 206 is complete. For another example, the presentation module 706 can display the destination indicator 330 in the particular instance of the contact region 204 where the subsequent spot 308 is detected.

For further example, the presentation module 706 can display a plurality of the destination indicator 330 based on the entry type 302. More specifically, based on the user entry 206, the presentation module 706 can display the destination indicator 330, change the lock state 332, or a combination thereof. For example, by moving the activation spot 216 from one instance of the contact region 204 to another instance of the contact region 204, the presentation module 706 can change the display of the destination indicator 330.

For a specific example, by moving the activation spot 216 from the first sub-region 208 to the second sub-region 210, the presentation module 706 can display all instances of the destination indicator 330 available on the first device 102. For a different example, by moving the activation spot 216 from the first sub-region 208 to the third sub-region 212, the presentation module 706 can display one instance of the destination indicator 330 available on the first device 102. For further example, by moving the activation spot 216 from the first sub-region 208 to the fourth sub-region 214, the presentation module 706 can display some instances of the destination indicator 330 available on the first device 102. For some instances of the destination indicator 330, the user, the computing system 100, or a combination thereof can define the number of instances of the destination indicator 330 to display.

Similarly, as an example, by moving the activation spot 216 from the first sub-region 208 to the second sub-region 210, the presentation module 706 can change the lock state 332 for all instances of the destination indicator 330 available on the first device 102. For a different example, by moving the activation spot 216 from the first sub-region 208 to the third sub-region 212, the presentation module 706 can change the lock state 332 of one instance of the destination indicator 330 available on the first device 102. For further example, by moving the activation spot 216 from the first sub-region 208 to the fourth sub-region 214, the presentation module 706 can change the lock state 332 for some instances of the destination indicator 330 available on the first device 102. For some instances of the destination indicator 330, the user, the computing system 100, or a combination thereof can define the number of instances of the destination indicator 330 to change the lock state 332.

For a different example, the presentation module 706 can display the content preview 338 of FIG. 3 based on the entry type 302, the contact region 204, the interface characteristic 314, or a combination thereof. More specifically, the entry type 302 can represent a scrub. The activation spot 216 can be detected in the first sub-region 208. The gesture direction 312 can represent left to right. Based on the entry 302, the contact region 204, the presentation module 706 can display the content preview 338 from the left extent towards the right extent of the display interface 202 by the user dragging the right extent of the content preview 338.

In contrast, if the activation spot 216 is detected within the second sub-region 210 and the gesture direction 312 is from the top extent towards the bottom extent of the display interface 202, the presentation module 706 can display the content preview 338 from the top extent towards the bottom extent of the display interface 202 by the user dragging the bottom extent of the content preview 338. As an example, the presentation module 706 can display the content preview 338 from all extents of the display interface 202 based on the contact region 204, the gesture direction 312, or a combination thereof.

For further example, the user can release the finger from the display interface 202 after dragging the content preview 338, thus, the activation spot 216 is no longer detected. As a result, the content preview 338 that has been dragged across the display interface 202 can return or gradually uncover the display interface 202 once the activation spot 216 is no longer detected. Moreover, the content preview 338 can slide back to the extent of the display interface 202 originally dragged from indicating that the user did not commit to the device content 324, the destination indicator 330, or a combination thereof. In contrast, the user can commit to the device content 324, the destination indicator 330, or a combination thereof if the user covers the display interface 202 in its entirety with the content preview 338.

It has been discovered that the computing system 100 displaying the content preview 338 can improve the efficiency of the user accessing the device content 324. By displaying the content preview 338, the computing system 100 can provide a sneak preview of the device content 324, the destination indicator 330, or a combination thereof that the user can access without fully committing to the device content 324, the destination indicator 330. As a result, the content preview 338 provides flexibility to control the computing system 100 for improved access and enhanced user experience for operating the computing system 100, the first device 102, or a combination thereof.

For a different example, the presentation module 706 can display the scrollbar 402 of FIG. 4 based on the entry type 302, the contact region 204, the interface characteristic 314, or a combination thereof. More specifically, if the entry type 302 represents a long press, the presentation module 706 can display the scrollbar 402 having the bar orientation 410 of FIG. 4 parallel to the long display side 328. Furthermore, based on the gesture direction 312, the presentation module 706 can display and change the bar cursor 404 of FIG. 4 with the cursor direction 406 of FIG. 4. Details regarding the scrollbar being manipulated will be discussed below.

For a different example, the presentation module 706 can provide the device response 412 of FIG. 4. The contact region 204 can represent a shape of circle. More specifically, one instance of the contact region 204 can be surrounded by another instance of the contact region 204. As the activation spot 216 moves from one instance of the contact region 204 to another, the presentation module 706 can provide the device response 412, such as a vibration, to indicate that the activation spot 216 has changed from one instance of the contact region 204 to another instance of the contact region 204.

For a different example, the presentation module 706 can display the content lane 508 of FIG. 5 based on the use context 514 of FIG. 5. As an example, the presentation module 706 can display the content lane 508 based on the use frequency 510 of FIG. 5, the use timing 512 of FIG. 5, or a combination thereof. More specifically, the display interface 202 can display two instances of the content lane 508. For example, the device orientation 502 can represent the vertical mode 504. The content lane 508 can also be in the vertical mode 504 with a plurality of the device content 324 can be displayed from the top extent to the bottom extent of the display interface 202.

As an example, the left column instance of the content lane 508 can display the device content 324 based on the use frequency 510 and the right column instance of the content lane 508 can display the device content 324 based on the use timing 512. More specifically, the left column instance of the content lane 508 can have the device content 324 with the most frequently used to be displayed at the top extent of the content lane 508. And the right column instance of the content lane 508 can have the device content 324 with the most recently used to be displayed at the top extent of the content lane 508.

It has been discovered the computing system 100 displaying the content lane 508 based on the use frequency 510, the use timing 512, or a combination thereof can improve the presentation of the device content 324. By providing the content lane 508, the computing system 100 can improve the access to the device content 324. As a result, the computing system 100 can enhance the user experience of the first device 102, the computing system 100, or a combination thereof.

For illustrative purposes, the computing system 100 is described with the interface module 704 determining the interface characteristic 314, although it is understood that the interface module 704 can operate differently. For example, the interface module 704 can determine the bar orientation 410, the cursor direction 406, or a combination thereof of the scrollbar 402.

The interface module 704 can determine the bar orientation 410, the cursor direction 406, or a combination thereof in a number of ways. For example, as discussed above, the scrollbar 402 can displayed where the activation spot 216 is detected or on a fixed location of the display interface 202 different from the activation spot 216 is detected. The interface module 704 can determine the bar orientation 410, the cursor direction 406, or a combination thereof based on the entry type 302.

For a specific example, the interface module 704 can determine the bar orientation 410, the cursor direction 406, or a combination thereof based on the gesture direction 312. As an example, the gesture direction 312 can be from the bottom extent to the top extent of the display interface 202. The interface module 704 can determine the bar orientation 410 to orient from the bottom extent to the top extent of the display interface 202. For another example, if the gesture direction 312 is from the left extent to the right extent of the display interface 202, the interface module 704 can determine the bar orientation 410 to orient from the left extent to the right extent of the display interface 202.

Continuing with the example, the interface module 704 can determine the cursor direction 406 of the bar cursor 404 to move along the bar orientation 410. More specifically, if the bar orientation 410 is from the bottom extent to the top extent of the display interface 202, the cursor direction 406 of the bar cursor 404 can also move in a direction from the bottom extent to the top extent along the scrollbar 402.

For a different example, the interface module 704 can determine the bar orientation 410 based on the gesture direction 312 that is neither perpendicular nor parallel to the extents of the display interface 202. More specifically, the gesture direction 312 can represent the user entry 206 of swipe moving from the bottom left corner of the display interface 202 moving towards the top right corner of the display interface 202. As a result, the interface module 704 can determine the bar orientation 410 to represent a diagonal from the bottom left corner extending towards the top right corner.

It has been discovered the computing system 100 determining the bar orientation 410 based on the gesture direction 312 can improve the presentation of the device content 324. By dynamically changing the bar orientation 410 based on the gesture direction 312, the computing system 100 can improve the access to the device content 324. As a result, the computing system 100 can enhance the user experience of the first device 102, the computing system 100, or a combination thereof.

For further example, the interface module 704 can determine the destination indicator 330 based on the bar position 408 of FIG. 4 of the scrollbar 402. The scrollbar 402 can be segmented into 4 instances of the bar position 408. The initial spot 306 or the starting position can represent the middle of the scrollbar 402. Based on the bar position 408, the interface module 704 can determine the destination indicator 330 to display, the device content 324 to unlock, or a combination thereof.

For example, the bar orientation 410 can represent perpendicular to the vertical mode 504 of the display interface 202. If the bar cursor 404 is moved to the right extent of the scrollbar 402, the interface module 704 can determine the lock state 332 to be changed to unlock state of the first device 102. For a different example, if the bar cursor 404 is moved to 1 position left of the initial spot 306, the interface module 704 can determine to display the destination indicator 330 for camera, launch the device content 324 representing camera, or a combination thereof. The interface module 704 can determine to have the device response 412, such as vibrate, when the bar cursor 404 arrives at the bar position 408.

It has been discovered the computing system 100 determining the destination indicator 330 based on the bar position 408 can improve the presentation of the device content 324. By segmenting the scrollbar 402 with the bar position 408, the computing system 100 can improve the access to the device content 324. As a result, the computing system 100 can enhance the user experience of the first device 102, the computing system 100, or a combination thereof.

The physical transformation from changing the activation spot 216 from the initial spot 306 to the subsequent spot 308 results in the movement in the physical world, such as people using the first device 102, based on the operation of the computing system 100. As the movement in the physical world occurs, the movement itself creates additional information that is converted back into determining the coloration gradient 316, the displaying of the destination indicator 330, or a combination thereof for the continued operation of the computing system 100 and to continue movement in the physical world.

The first software 626 of FIG. 6 of the first device 102 of FIG. 6 can include the computing system 100. For example, the first software 626 can include entry module 702, the interface module 704, and the presentation module 706.

The first control unit 612 of FIG. 6 can execute the first software 626 for the entry module 702 to determine the entry type 302. The first control unit 612 can execute the first software 626 for the interface module 704 to determine the interface characteristic 314. The first control unit 612 can execute the first software 626 for the presentation module 706 to provide the device content 324.

The second software 642 of FIG. 6 of the second device 106 of FIG. 6 can include the computing system 100. For example, the second software 642 can include entry module 702, the interface module 704, and the presentation module 706.

The second control unit 634 of FIG. 6 can execute the second software 642 for the entry module 702 to determine the entry type 302. The second control unit 634 can execute the second software 642 for the interface module 704 to determine the interface characteristic 314. The second control unit 634 can execute the second software 642 for the presentation module 706 to provide the device content 324.

The computing system 100 can be partitioned between the first software 626 and the second software 642. For example, the second software 642 can include entry module 702 and the interface module 704. The second control unit 634 can execute modules partitioned on the second software 642 as previously described.

The first software 626 can include the presentation module 706. Based on the size of the first storage unit 614, the first software 626 can include additional modules of the computing system 100. The first control unit 612 can execute the modules partitioned on the first software 626 as previously described.

The first control unit 612 can operate the first communication interface 628 of FIG. 6 to communicate the entry type 302, the interface characteristic 314, the device content 324, or a combination thereof to or from the second device 106. The first control unit 612 can operate the first software 626 to operate the location unit 620. The second communication interface 650 of FIG. 6 to communicate the entry type 302, the interface characteristic 314, the device content 324, or a combination thereof to or from the first device 102. Furthermore, the presentation module 706 can represent the first user interface 618 of FIG. 6, the second user interface 638 of FIG. 6, or a combination thereof.

The computing system 100 describes the module functions or order as an example. The modules can be partitioned differently. For example, the entry module 702 and the interface module 704 can be combined. Each of the modules can operate individually and independently of the other modules. Furthermore, data generated in one module can be used by another module without being directly coupled to each other. For example, the presentation module 706 can receive the entry type 302 from the entry module 702.

The modules described in this application can be hardware implementation or hardware accelerators in the first control unit 612 or in the second control unit 634. The modules can also be hardware implementation or hardware accelerators within the first device 102 or the second device 106 but outside of the first control unit 612 or the second control unit 634, respectively as depicted in FIG. 6. However, it is understood that the first device 102, the second device 106, or a combination thereof can collectively refer to all hardware accelerators for the modules. Furthermore, the first device 102, the second device 106, or a combination thereof can be implemented as software, hardware, or a combination thereof.

The modules described in this application can be implemented as instructions stored on a non-transitory computer readable medium to be executed by the first device 102, the second device 106, or a combination thereof. The non-transitory computer medium can include the first storage unit 614, the second storage unit 646 of FIG. 6, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

The control flow 700 or a method 700 of operation of a computing system 100 in an embodiment of the present invention. The method 700 includes: determining an entry type based on detecting an activation spot in a block 702; determining an interface characteristic based on the entry type in a block 704; and providing a device content based on the interface characteristic for presenting on a device in a block 706.

It has been discovered that the computing system 100 determining the entry type 302 based on detecting the activation spot 216 can improve the efficiency of accessing the device content 324. By determining the interface characteristic 314 based on the entry type 302, the computing system 100 can tailor the device content 324 presented on the display interface 202. As a result, the computing system 100 can enhance the user experience for operating the first device 102, the computing system 100, or a combination thereof.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the embodiment of the present invention is that it valuably supports and services the historical trend of reducing costs, simplifying systems, and increasing performance. These and other valuable aspects of the embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a control unit configured to
determine an entry type based on detecting an activation spot,
determine an interface characteristic based on the entry type,
provide a device content based on the interface characteristic, and
a communication interface, coupled to the control unit, configured to communicate the device content for presenting on a device.

2. The system as claimed in claim 1 wherein the control unit is configured to display the device content based on the activation spot detected within a contact region.

3. The system as claimed in claim 1 wherein the control unit is configured to display a device indicator having a coloration gradient changed based on a gesture direction.

4. The system as claimed in claim 1 wherein the control unit is configured to change an interface coloration, a content coloration, an edge coloration, or a combination thereof based on a gesture direction.

5. The system as claimed in claim 1 wherein the control unit is configured to determine a destination indicator based on a bar position of a scrollbar.

6. The system as claimed in claim 1 wherein the control unit is configured to determine an interface coloration based on a contact region where the activation spot is detected.

7. The system as claimed in claim 1 wherein the control unit is configured to determine a content coloration based on a contact region where the activation spot is detected.

8. The system as claimed in claim 1 wherein the control unit is configured to determine an edge coloration based on a contact region where the activation spot is detected.

9. The system as claimed in claim 1 wherein the control unit is configured to change a content size of the device content based on where the activation spot is detected.

10. The system as claimed in claim 1 wherein the control unit is configured to determine a lock state based on the a device orientation changing from a vertical mode to a horizontal mode or vice versa.

11. A method of operation of a computing system comprising:
determining an entry type based on detecting an activation spot;
determining an interface characteristic based on the entry type; and
providing a device content based on the interface characteristic for presenting on a device.

12. The method as claimed in claim 11 further comprising displaying the device content based on the activation spot detected within a contact region.

13. The method as claimed in claim 11 further comprising displaying a device indicator having a coloration gradient changed based on a gesture direction.

14. The method as claimed in claim 11 further comprising changing an interface coloration, a content coloration, an edge coloration, or a combination thereof based on a gesture direction.

15. The method as claimed in claim 11 further comprising determining a destination indicator based on a bar position of a scrollbar.

16. A computing system including a user interface comprising:
a contact region configured to detect an activation spot; and
a content preview configured to overlap the contact region based on a gesture direction of a user entry.

17. The user interface as claimed in claim 16 further comprising a content lane configured to display the device content based on a use frequency, a use timing, or a combination thereof.

18. The user interface as claimed in claim 16 wherein the contact region includes a first sub-region, a second sub-region, a third sub-region, a fourth sub-region, or a combination thereof configured to detect the activation spot.

19. The user interface as claimed in claim 16 wherein the scrollbar includes the scrollbar having a bar position configured to detect a bar cursor for triggering the device content to be presented.

20. The user interface as claimed in claim 16 further comprising a scrollbar having a bar orientation along with the contact region configured to access a device content.
